(19) United States
(12) Patent Application Publication
(10) Pub. No.: US 2026/0155041 A1
(43) Pub. Date: Jun. 4, 2026

(54) COMPUTER-IMPLEMENTED METHOD FOR PREDICTING AND/OR PLANNING TRAJECTORIES FOR PARTICIPANTS IN A TRAFFIC SCENE, AND COMPUTER-IMPLEMENTED METHOD FOR TRAINING A MODEL FOR PREDICTING AND/OR PLANNING TRAJECTORIES FOR PARTICIPANTS IN A TRAFFIC SCENE

(71) Applicant: Robert Bosch GmbH, Stuttgart (DE)

(72) Inventors: Martin Stoll, Renningen (DE); Maxim Dolgov, Renningen (DE)

(21) Appl. No.: 19/396,738

(22) Filed: Nov. 21, 2025

(30) Foreign Application Priority Data
Nov. 29, 2024 (DE) 10 2024 211 431.6

(51) Int. Cl. G08G 1/01; G06N 20/00

(52) U.S. Cl. CPC G08G 1/0145; G06N 20/00

(57) ABSTRACT

A computer-implemented method for predicting and/or planning at least one trajectory for at least one participant in a traffic scene. On the basis of aggregated scene-specific information and using a pre-trained model, at least one trajectory for the at least one participant is generated, wherein each trajectory is represented by a sequence of spatio-temporal waypoints. For the trajectory of a participant, spatio-temporal waypoints are generated that have predefined distances from a common reference point, in particular predefined distances from the current position of the participant.

### CROSS REFERENCE

The present application claims the benefit under 35 U.S.C. § 119 of Germany Patent Application No. DE 10 2024 211 431.6 filed on Nov. 29, 2024, which is expressly incorporated herein by reference in its entirety.

### FIELD

The present invention relates to a computer-implemented method for predicting and/or planning at least one trajectory for at least one participant in a traffic scene, in which, on the basis of aggregated scene-specific information and using a pre-trained model, at least one trajectory for the at least one participant is generated, wherein each trajectory is represented by a sequence of spatio-temporal waypoints.

The preferred field of application of the present invention is autonomous driving. However, other applications are also possible, for example in the field of robotics.

### BACKGROUND INFORMATION

The task of autonomous driving is to control an ego vehicle solely on the basis of sensor data, for example radar, lidar and RGB camera data, as well as other aggregated scene-specific information such as, for example, map information, traffic situation information, weather and road condition information, in such a way that a destination is reached as quickly, comfortably and safely as possible. As much as possible, the ego vehicle should comply with all traffic rules, not cause any collisions with other road users or objects, and not be involved in any collisions. This task can be divided into the subtasks of perception, prediction, planning and control.

The task of perception is initially to aggregate sensor data describing a given traffic scene, as well as any other scene-specific information. Often, but not necessarily, perception includes not only the collection of data but also the processing of these data in order to extract “relevant” information from the abundance of aggregated sensor data and other scene-specific information. This includes the detection and classification of static and dynamic objects and road users, as well as the determination of the position and state of motion of the detected objects or road users. On the basis of the extracted relevant information, an environment model of the traffic scene can then be generated, for example.

The task of prediction is to forecast or estimate the future development of the traffic scene on the basis of aggregated scene-specific information, optionally using an environment model. Typically, the future behavior of each detected and observed participant is predicted individually, in the form of at least one trajectory that the observed participant is expected to follow. Information about the past development of the traffic scene can also be taken into account, for example the positions and conditions of other road users, as well as infrastructure information collected over an observation horizon in the past. Because the destination of the observed participants is naturally unknown, predicting a single behavior, i.e., a single trajectory, is typically insufficient. Instead, a number, usually 6-10, of potential future trajectories for a participant is predicted.

The results of the prediction are used during planning to ascertain a goal-directed, maximally safe policy for the ego vehicle. The control system or a trajectory controller then translates the corresponding trajectory into control commands for the actuator system of the ego vehicle in order to implement the planned trajectory.

It is conventional to use models based on artificial intelligence (AI) and trained for the relevant task for prediction and/or planning.

In the context of the present invention, trajectories are represented by a sequence of spatio-temporal waypoints, i.e., by a sequence of position and associated time values. The position value is usually specified as an absolute position (x, y, z) in a defined coordinate system, for example a global coordinate system or a local coordinate system of the vehicle. The associated time value is usually a time stamp indicating the point in time at which the participant is or will be located at the relevant position.

In addition to position and time values, the trajectory data can also include a variety of additional information describing how the participant in question moves, or will move, through space.

A frequently used piece of additional spatial information is the orientation, i.e., the alignment of the participant in space, in the form of yaw, pitch, and roll angles. In particular, the yaw angle allows conclusions to be drawn about the direction of movement. Furthermore, the trajectory data can include information about the spatial extent of the participant, for example in the form of a bounding box. This information is important for collision avoidance in particular.

Trajectory data often also include movement data about the participant, such as speed values, acceleration values, and values relating to angular velocity.

Finally, it should be mentioned here that the trajectory data can also include values relating to the probability or uncertainty of the individual predicted spatio-temporal waypoints, which can then be taken into account, for example, during planning.

Prediction and planning methods of the type discussed here typically generate trajectories having a predefined number of waypoints at fixed time intervals. The path length of a trajectory then results from the product of the speed of the relevant participant and the planning horizon, typically 3 to 8 seconds. Accordingly, the path length of the predicted or planned trajectories varies significantly, as a function of the speed of the relevant participant.

This often proves to be problematic in practice. Thus, at high speeds, the distance between the individual spatio-temporal waypoints of a planned trajectory can become so large that the information about the exact course of the trajectory is insufficient. When driving slowly or when stationary, the spatio-temporal waypoints are close together. In this case, the planned trajectory is very short and provides only a limited look-ahead distance in meters. This proves problematic in particular when controlling lateral vehicle movement, as this requires a minimum look-ahead distance. The problem is particularly evident when stopping and subsequently starting again. Overall, the discrete-time trajectory representation makes it difficult to interpret the planned maneuver, because, when stationary, it is not apparent where the policy intends to drive.

### SUMMARY

With the present invention, measures are provided that improve the interpretability of predicted and/or planned trajectories with regard to the intention of the relevant participant, and that simplify the safe implementation or adjustment of planned trajectories.

According to the present invention, this is achieved by generating, for the trajectory of a participant, spatio-temporal waypoints that have predefined distances from a common reference point, in particular predefined distances from the current position of the participant.

According to an example embodiment of the present invention, “discrete-space” trajectories are generated that, for a given number of spatio-temporal waypoints, always have a predefined minimum path length and thus ensure a minimum look-ahead distance in meters. This proves advantageous in particular when driving slowly or when stationary, e.g., at a traffic light, as, even in these cases, the trajectory reflects the predicted or planned intention of the participant.

In a preferred variant of the prediction or planning method according to the present invention, the number of spatio-temporal waypoints to be generated for a trajectory of a participant is predefined. This makes it very easy to predefine a minimum length for the trajectories to be generated.

As mentioned at the outset, different coordinate systems can be used to specify the location of the spatio-temporal waypoints. In an advantageous variant of the method according to the present invention, the spatio-temporal waypoints of the trajectory of a participant are generated relative to a predefined reference line. By way of example, a path predefined, by a navigation system, for reaching the destination and running along the centerline of a lane of a roadway could be used as the reference line. When using a suitably trained model, trajectories that run close to the reference line, i.e., to the centerline of a lane, are preferably generated. Such a model therefore has a bias to preferably generate trajectories along the lane line.

The use of “discrete-space” trajectories in behavior prediction and planning must be taken into account when training the model used for this purpose. Therefore, the present invention further relates to a computer-implemented method for training a model to predict and/or plan at least one trajectory for at least one participant in a traffic scene. According to an example embodiment of the present invention, the method comprises the following steps:
a. providing a training dataset with training samples, wherein each training sample comprises at least:
   a training input that was generated on the basis of aggregated scene-specific information, and
   a target trajectory represented by a sequence of spatio-temporal waypoints;
b. applying the training input of at least one training sample to the model to be trained in order to generate at least one training output trajectory having a predefined number of spatio-temporal waypoints;
c. evaluating the training output trajectory with regard to the target trajectory of the training sample; and
d. modifying the model as a function of the evaluation of the training output trajectory.

The type of training samples and in particular of the training input depends on the configuration of the model to be trained. Thus, unprocessed scene-specific information, such as raw sensor data, or pre-processed and/or evaluated scene-specific information, such as an environment model that was generated on the basis of the aggregated scene-specific information, can be used as training input.

The target trajectories are usually provided in the form of discrete-time trajectories, i.e., in each case in the form of a sequence of spatio-temporal waypoints at equidistant temporal distances.

According to an example embodiment of the present invention, the model to be trained generates spatio-temporal waypoints for the training output trajectory that have predefined distances from a common reference point. In order to evaluate the training output trajectory, a spatial distance and a temporal distance from the target trajectory are determined for each spatio-temporal waypoint of the training output trajectory. These two distances are then combined in a loss function in order to modify the model in a further step with regard to optimizing the loss function.

It should be noted at this point that the individual spatio-temporal waypoints of the training output trajectory and the target trajectory generally do not correspond to one another, as they differ in both location and time values. According to the present invention, the evaluation of the training output trajectory is based on the spatial and temporal distances of the individual spatio-temporal waypoints from the target trajectory.

In order to determine these distances, the spatio-temporal waypoints of the target trajectory are interpolated in an advantageous development of the training method according to the present invention. The spatial distance and temporal distance between a spatio-temporal waypoint of the training output trajectory and the target trajectory can then be easily determined by comparing the spatio-temporal waypoint of the training output trajectory with the spatio-temporal waypoint of the interpolated target trajectory that has the same distance from a reference point as the spatio-temporal waypoint of the training output trajectory.

During training, each spatio-temporal waypoint of the training output trajectory is assigned to a specific point of the target trajectory. For the loss function, a spatial and a temporal distance are then determined for each pair of points formed in this way, for example using the Huber loss function. The Huber loss function is a combination of the mean squared error (MSE) and the mean absolute error (MAE). It is more robust against outliers than the MSE while remaining differentiable, which is important for training a neural network.

Spatial and temporal distances can also be defined by differences between two points. For example, thresholding using a Rectified Linear Unit (ReLU) can be used to ensure that the temporal distances between waypoints increase monotonically. This means that each subsequent waypoint lies in the future, not in the past. This assumption is particularly useful in the context of behavior prediction and planning.

In an advantageous embodiment of the training method according to the present invention, the spatial distance and the temporal distance are weighted differently in the loss function.

Because the “discrete-space” trajectory representation according to the present invention allows for a simple distribution of the deviations of the training trajectory from the target trajectory into a cross-sectional profile, represented by the position values of the spatio-temporal waypoints, and longitudinal or speed profile, represented by the time values of the spatio-temporal waypoints, these contributions can be taken into account differently in the overall loss. By appropriately selecting the parameters of the loss function, either the cross-sectional profile or the longitudinal profile can be given greater importance.

The present invention also relates to a computer-implemented system for controlling a vehicle, comprising at least:
a. a perception layer for capturing and preprocessing scene-specific information,
b. a planning model for planning at least one trajectory for the vehicle, wherein the planning model is designed and trained to generate “discrete-space” trajectories according to the present invention, and
c. a control module for controlling the actuator system of the vehicle for it to implement a trajectory generated by the planning model.

In an advantageous embodiment of the present invention, such a system further comprises a prediction model that is designed and trained to, according to the present invention, predict “discrete-space” trajectories for at least one other participant in a traffic scene.

### BRIEF DESCRIPTION OF THE DRAWINGS

An exemplary embodiment and advantageous developments of the present invention are explained in more detail below in conjunction with the figures.

FIG. 1 illustrates the concept of behavior prediction and/or planning based on a trajectory represented by a sequence of spatio-temporal waypoints at temporally equidistant distances, as is conventional in the related art.

FIG. 2 illustrates the concept of a “discrete-space” trajectory representation underlying a method according to the present invention for behavior prediction and/or planning.

### DETAILED DESCRIPTION OF EXAMPLE EMBODIMENTS

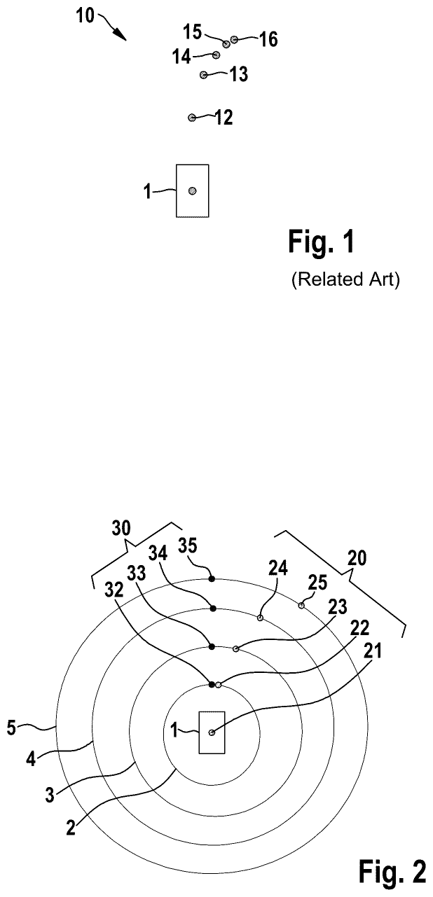

In FIG. 1, a vehicle 1 is shown, schematically in a bird's-eye view. Also shown is a trajectory 10 that was planned for the vehicle 1 using a related art method. For this purpose, a sequence of five spatio-temporal waypoints 12 to 16 was generated for a planning horizon of a predefined time period, which spatio-temporal waypoints, together with the starting point 11, represent the trajectory 10. A planning constraint was that the spatio-temporal waypoints 11, 12 to 16 were equally spaced in time, i.e., the points in time were predefined, whereas the two spatial coordinates x, y of the waypoints were used as degrees of freedom for the planning. In this type of planning, the speed of vehicle 1 when following trajectory 10 must be regulated so that the temporal intervals between passing the individual spatio-temporal waypoints 11, 12 to 16 are of equal length. Since, in the case of the example shown here, the spatial distance between the spatio-temporal waypoints 11, 12 to 16 decreases further and further as the distance from the starting point 11 increases, the vehicle 1 should therefore reduce its speed accordingly when traveling along the trajectory 10.

FIG. 1 illustrates that, in the case of planning based on a trajectory having spatio-temporal waypoints equally spaced in time, the look-ahead distance in meters decreases as the speed of the vehicle in question decreases.

In FIG. 2, a vehicle 1 is likewise shown in a bird's-eye view together with a trajectory 20. Said trajectory is represented here by a starting point 21 and a sequence of four spatio-temporal waypoints 22 to 25. The trajectory 20 was planned using a method according to the present invention on the basis of aggregated scene-specific information and using a pre-trained planning model. Accordingly, the spatio-temporal waypoints 22 to 25 each have a predefined distance from a common reference point 21. In the present exemplary embodiment, the current position of vehicle 1 is used as reference point 21. This also represents starting point 21 of trajectory 20. The predefined distances of the spatio-temporal waypoints 22 to 25 from the common reference point 21 are illustrated here by the fact that each individual spatio-temporal waypoint 22 to 25 lies on one of four circles 2 to 5 drawn concentrically about the reference point 21.

According to the present invention, the planning model therefore has only one degree of freedom when generating the waypoints. The second degree of freedom lies in that, for each waypoint, a time value for reaching that waypoint is regressed. Accordingly, the planning horizon of the trajectories generated according to the present invention depends substantially on the speed of the relevant participant or vehicle, whereas the path length is completely independent of the speed of the participant, but is determined substantially by the predefined distances of the individual spatio-temporal waypoints of the trajectory from the common reference point.

FIG. 2 illustrates that, with a plan based on a “discrete-space” trajectory according to the present invention, a look-ahead can be ensured over a minimum distance, regardless of the speed of the relevant participant.

In the exemplary embodiment shown here, the waypoints φ of the spatio-temporal waypoints (φ, t) 22 to 25 were regressed relative to a reference line 30. This could, for example, be a route recommendation from a navigation system. The reference line 30 likewise starts from the starting point 21 and is represented by a sequence of reference points 32 to 35. These likewise each lie on one of the four circles 2 to 5 and thus have the distances from the common reference point 21 that were predefined for the spatio-temporal waypoints 22 to 25 of the trajectory 20. To determine the spatial points of the spatio-temporal waypoints (φ, t) 22 to 25, the angular deviations φ from the respective reference points 32 to 35 having the same distance from the reference point 21 were regressed.

Alternatively, the spatial points of the spatio-temporal waypoints could also be specified as an arc length with respect to the reference point, or as 2D coordinates (x, y) with an additional loss of the points on the appropriate circle, or as 2D coordinates (x, y) with additional normalization to ensure that the relevant point lies on the appropriate circle.

What is claimed is:

1. A computer-implemented method for predicting and/or planning at least one trajectory for at least one participant in a traffic scene, the method comprising:
generating, based on aggregated scene-specific information and using a pre-trained model, at least one trajectory for the at least one participant, wherein each trajectory is represented by a sequence of spatio-temporal waypoints;
wherein, for the at least one trajectory for the at least one participant, the spatio-temporal waypoints are generated that have predefined distances from a common reference point including predefined distances from a current position of the at least one participant.

2. The method according to claim 1, wherein a number of the spatio-temporal waypoints that are generated for each of the at least one trajectory of the at least one participant is predefined.

3. The method according to claim 1, wherein the spatio-temporal waypoints of the at least one trajectory of the at least one participant are generated relative to a predefined reference line.

4. A computer-implemented method for training a model to implement a method for predicting and/or planning at least one trajectory for at least one participant in a traffic scene, the method comprising the following steps:
a) providing a training dataset with training samples, wherein each of the training samples includes at least:
a training input that was generated based on aggregated scene-specific information, and
a target trajectory represented by a sequence of spatio-temporal waypoints;
b) applying as training input a training sample of the training samples to the model to be trained to generate a training output trajectory having a predefined number of spatio-temporal waypoints;
c) evaluating the training output trajectory with regard to the target trajectory of the training sample; and
d) modifying the model as a function of the evaluation of the training output trajectory;
wherein the model to be trained generates spatio-temporal waypoints for the training output trajectory that have predefined distances from a common reference point, wherein to evaluate the training output trajectory, a spatial distance and a temporal distance from the target trajectory are determined for each spatio-temporal waypoint of the training output trajectory, and the spatial distance and the temporal distance are combined in a loss function; and
wherein the model is modified with regard to optimizing the loss function.

5. The method according to claim 4, wherein the spatio-temporal waypoints of the target trajectory are interpolated to determine the spatial distance and the temporal distance from individual ones of the spatio-temporal waypoints of the training output trajectory.

6. The method according to claim 5, wherein the spatial distance and the temporal distance between each spatio-temporal waypoint of the training output trajectory and the target trajectory are determined by comparing the spatio-temporal waypoint of the training output trajectory with the spatio-temporal waypoint of the interpolated target trajectory that has the same distance from a reference point as the spatio-temporal waypoint of the training output trajectory.

7. The method according to claim 4, wherein the spatial distance and the temporal distance are weighted differently in the loss function.

8. A computer-implemented system for controlling a vehicle, comprising:
a) a perception layer configured to capture and preprocess scene-specific information;
b) a planning model configured to plan at least one trajectory for the vehicle by:
generating, based on aggregated scene-specific information, the at least one trajectory for the vehicle, wherein each trajectory is represented by a sequence of spatio-temporal waypoints,
wherein, for the at least one trajectory for the vehicle, the spatio-temporal waypoints are generated that have predefined distances from a common reference point including predefined distances from a current position of the vehicle, and
c) a control module configured to control an actuator system of the vehicle to implement a trajectory of the at least one trajectory generated by the planning model.

9. The system according to claim 8, wherein the planning model is pre-trained by:
a) providing a training dataset with training samples, wherein each of the training samples includes at least:
a training input that was generated based on aggregated scene-specific information, and
a target trajectory represented by a sequence of spatio-temporal waypoints;
b) applying as training input a training sample of the training samples to the planning model to generate a training output trajectory having a predefined number of spatio-temporal waypoints;
c) evaluating the training output trajectory with regard to the target trajectory of the training sample; and
d) modifying the planning model as a function of the evaluation of the training output trajectory;
wherein to evaluate the training output trajectory, a spatial distance and a temporal distance from the target trajectory are determined for each spatio-temporal waypoint of the training output trajectory, and the spatial distance and the temporal distance are combined in a loss function; and
wherein the planning model is modified with regard to optimizing the loss function.

10. The system according to claim 8, further comprising:
a prediction model configured to predict at least one trajectory of at least one other participant in a traffic scene by:
generating, based on the aggregated scene-specific information, at least one trajectory for the at least one other participant, wherein each trajectory for the at least one other participant is represented by a sequence of spatio-temporal waypoints;
wherein, for the at least one trajectory for the at least one other participant, the spatio-temporal waypoints are generated that have predefined distances from a common reference point including predefined distances from a current position of the at least one other participant.

11. The system according to claim 10, wherein the prediction model is pre-trained by:
a) providing a training dataset with training samples, wherein each of the training samples includes at least:
a training input that was generated based on aggregated scene-specific information, and
a target trajectory represented by a sequence of spatio-temporal waypoints;
b) applying as training input a training sample of the training samples to the prediction model to generate a training output trajectory having a predefined number of spatio-temporal waypoints;
c) evaluating the training output trajectory with regard to the target trajectory of the training sample; and
d) modifying the prediction model as a function of the evaluation of the training output trajectory;
wherein to evaluate the training output trajectory, a spatial distance and a temporal distance from the target trajectory are determined for each spatio-temporal waypoint of the training output trajectory, and the spatial distance and the temporal distance are combined in a loss function; and
wherein the prediction model is modified with regard to optimizing the loss function
